(19) United States
(12) Patent Application Publication
(10) Pub. No.: US 2026/0085899 A1
(43) Pub. Date: Mar. 26, 2026

(54) REFRACTORY METAL HEAT EXCHANGERS WITH EMBEDDED SENSORS AND RELATED METHODS

(71) Applicants: Battelle Energy Alliance, LLC, Idaho Falls, ID (US); University of Notre Dame DU LAC, South Bend, IN (US)

(72) Inventors: Xinchang Zhang, Idaho Falls, ID (US); Jorgen F. Rufner, Idaho Falls, ID (US); Michael D. McMurtrey, Idaho Falls, ID (US); Yanliang Zhang, Granger, IN (US)

(21) Appl. No.: 19/340,474

(22) Filed: Sep. 25, 2025

Related U.S. Application Data
(60) Provisional application No. 63/699,048, filed on Sep. 25, 2024.

(51) Int. Cl. F28F 21/08; B22F 10/20; B33Y 10/00; B33Y 40/00; B33Y 80/00; F28F 21/04

(52) U.S. Cl. CPC F28F 21/08; B22F 10/20; B33Y 10/00; B33Y 40/00; B33Y 80/00; F28F 21/04; F28F 2255/146; F28F 2255/18

(57) ABSTRACT

A heat exchanger includes a body formed of a refractory metal alloy. The body defines one or more fluid passageways therein. A sensor is embedded in an inner surface of the one or more fluid passageways. A method of forming a heat exchanger includes additively manufacturing a shapeholder with elongated bodies that correspond to fluid passageways to be defined within a body. The method also includes additively manufacturing one or more sensors on the elongated bodies of the shapeholder. A material of the body is formed and sintered around the elongated bodies of the shapeholder and the one or more sensors. The shapeholder is removed from the body, leaving the one or more sensors embedded at an inner surface of the fluid passageways.

### CROSS-REFERENCE TO RELATED APPLICATIONS

This application claims the benefit under 35 U.S.C. § 119(e) of U.S. Provisional Patent Application Ser. No. 63/699,048, filed Sep. 25, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to heat exchangers and related methods. More particularly, the disclosure relates to material compositions of heat exchangers and methods of forming heat exchangers with sensors in the heat exchanger.

### BACKGROUND

High-temperature compact heat exchangers are used in many industrial applications, such as power generation, chemical processing, and metallurgy. The compact heat exchangers are designed to transfer heat between fluids and are essential for improving energy efficiency and reducing environmental impact. Conventional high-temperature compact heat exchangers are made of nickel-based alloys through brazing, fusion welding, and diffusion bonding of sheets with etched channels on one side. The conventional compact heat exchangers have characteristics that make them unsuitable for use in harsh environments. Specifically, current materials for compact heat exchangers cannot provide sufficient mechanical strength at operating temperatures above 750° C. Moreover, these materials often have poor corrosion resistance in corrosive environments, such as molten salts.

The characteristics of conventional compact heat exchangers prevent an increase of working temperatures for higher efficiency, and they reduce the lifespan of the compact heat exchangers. Shorter lifespan increases the burden on materials reprocessing, decommissioning, and disposal. In addition, conventional manufacturing methods are challenging for processing high-temperature alloys and are unable to produce customizable compact heat exchanger designs. For example, diffusion bonding is challenging to achieve bonds between nickel alloy sheets and channels formed by diffusion bonding are largely constrained to a 2D design. The 2D designs cannot be expanded effectively to a 3D profile to take advantage of complex channel designs that can enhance heat transfer coefficient.

### SUMMARY

In one aspect a heat exchanger includes a body formed of a refractory metal alloy. The body defines one or more fluid passageways therein. A sensor is embedded in an inner surface of the one or more fluid passageways.

In one aspect, a method of forming a heat exchanger includes additively manufacturing a shapeholder with elongated bodies that correspond to fluid passageways to be defined within a body. The method also includes additively manufacturing one or more sensors on the elongated bodies of the shapeholder. A material of the body is formed around the elongated bodies of the shapeholder and is sintered around the elongated bodies of the shapeholder and the one or more sensors. The shapeholder is removed from the body, leaving the one or more sensors embedded at an inner surface of the fluid passageways.

In one aspect, a shapeholder for use in forming a heat exchanger with one or more sensors embedded within fluid passageways of the heat exchanger is provided. The shapeholder includes elongated bodies configured in a negative pattern corresponding to the fluid passageways of the heat exchanger. A ceramic capsule is disposed on an outer surface of one or more of the elongated bodies, and a sensor is disposed within the ceramic capsule. The elongated bodies include a first material that is reactive to a chemical solution, and the ceramic capsule includes a second material that is resistant to the chemical solution.

### BRIEF DESCRIPTION OF THE DRAWINGS

FIG. 1 is a perspective view of a heat exchanger in accordance with embodiments of the disclosure.

FIG. 2 is a perspective, cross-sectional view of the heat exchanger of FIG. 1.

FIG. 3 is a side elevational view of a shapeholder and a manufacturing device in accordance with embodiments of the disclosure.

FIG. 4A is a perspective view of the shapeholder of FIG. 3 and a manufacturing device in accordance with embodiments of the disclosure.

FIG. 4B illustrates an enlarged section view taken along the line A-A in FIG. 4A.

FIG. 5 is a perspective view of the shapeholder of FIG. 3 and a manufacturing device in accordance with embodiments of the disclosure.

FIG. 6 is a perspective view of the shapeholder of FIG. 3 within a die of a sintering assembly.

FIG. 7 is a side elevational view of the heat exchanger of FIG. 1.

FIG. 8 is a perspective view of the heat exchanger of FIG. 1.

FIG. 9 is a perspective view of a heat exchanger with a shapeholder embedded therein prior to removal in accordance with embodiments of the disclosure.

FIG. 10 is a method of forming a heat exchanger in accordance with embodiments of the disclosure.

### DETAILED DESCRIPTION

In the detailed description, the claims, and in the accompanying drawings, reference is made to particular features (including method acts) of the disclosure. It is to be understood that the disclosure includes all possible combinations of such features. For example, where a particular feature is disclosed in the context of a particular embodiment, or a particular claim, that feature can also be used, to the extent possible, in combination with and/or in the context of other aspects and embodiments described herein.

The following description provides specific details, such as components, assembly, and materials in order to provide a thorough description of embodiments of the disclosure. However, a person of ordinary skill in the art will understand that the embodiments of the disclosure may be practiced without employing these specific details.

The use of the term “for example,” means that the related description is explanatory, and though the scope of the disclosure is intended to encompass the examples and legal equivalents, the use of such terms is not intended to limit the scope of an embodiment of this disclosure to the specified components, acts, features, functions, or the like.

Drawings presented herein are for illustrative purposes and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured to” in reference to a structure or device intended to perform some function refers to size, shape, material composition, material distribution, orientation, and/or arrangement, etc., of the referenced structure or device.

As used herein, the terms “comprising” and “including,” and grammatical equivalents thereof are inclusive or open-ended terms that do not exclude additional, unrecited elements or method acts, but also include the more restrictive terms such as “consisting of” and “consisting essentially of”and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms following “a,” “an,” and “the” are intended to include the plural forms as well, unless the context clearly indicates otherwise.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

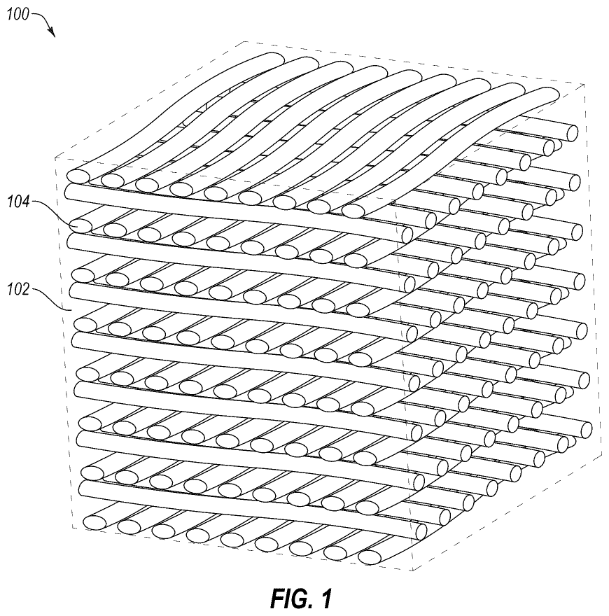

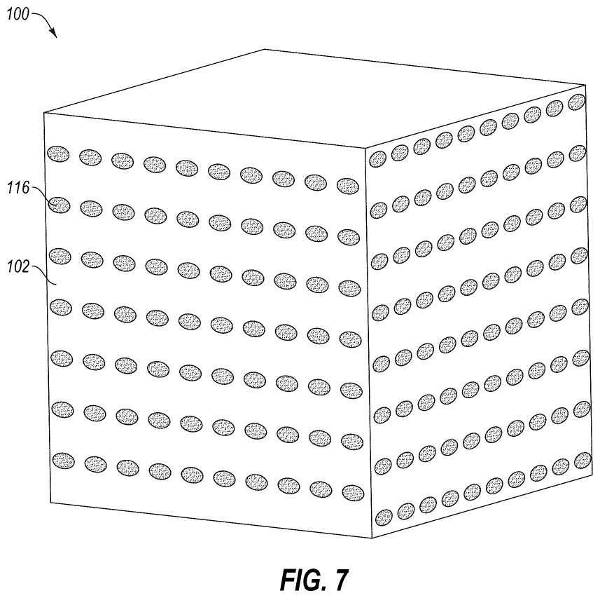

FIG. 1 shows an example of a heat exchanger 100 including a body 102 defining fluid passageways 104 therein. For convenience, FIG. 1 illustrates the body 102 as being partially transparent to show an exemplary geometry of the fluid passageways 104 defined within the body 102. An example of the body 102 of FIG. 1 in a nontransparent form is shown in FIG. 7. The heat exchanger 100 may be configured as a compact heat exchanger, such as a high-temperature compact heat exchanger. In some embodiments, the heat exchanger 100 may be configured for use at an operational temperature greater than or equal to about 750° C, such as from greater than or equal to about 750° C to about 1900° C, or such as from about 1100° C to about 1500° C. The heat exchanger 100 may be used in various fields and with various systems such as, but not limited to, concentrated solar power, power and chemical plants, steel making, and methane pyrolysis. The fluid passageways 104 may exhibit small dimensions and a high aspect ratio. A radius of the fluid passageways 104 may, for example, be between about 0.5 mm and about 6 mm. Exemplary lengths of the fluid passageways may be from about 50 mm to 1500 mm.

The body 102 may define the fluid passageways 104 of the heat exchanger 100 and may be formed substantially of a refractory metal alloy. The refractory metal alloy may be, for example, a molybdenum (Mo) and/or tungsten (W) base alloy. Other chemical elements may also be combined with the Mo and/or W base alloy. For example, one or more of zirconium (Zr), titanium (Ti), nickel (Ni), copper (Cu), or iron (Fe) may improve the tensile strength of pure Mo or W. If, for example, the refractory metal alloy includes W and Cu, the Cu may be present at from about 3 wt. % to about 10 wt. %. If the refractory metal alloy includes W, Cu, and Ni, the Cu may be present at from about 3 wt. % to about 5 wt. % and equal parts of the Ni may be present. Similar Mo-based alloys may also be used, such as Mo and Cu or Mo, Cu, and Ni. Lanthanum-doped titanium-zirconium-molybdenum (TZM) may improve tensile strength and elongation of the refractory metal alloy. La₂O₃ and Y₂O₃ may increase corrosion resistance of the refractory metal alloy. The refractory metal alloy may include any combination of the foregoing materials or equivalents thereof. In some embodiments, additional materials may be included with the refractory metal alloy such as iron and nickel.

The refractory metal alloy forming the body 102 may undergo hydrogen treatment, which may decrease oxide impurities and increase the density and mechanical strength of the material. Increased density may lead to increased hardness. Refractory metal alloys exhibit high melting points and have low ductility. The microstructure of the refractory metal alloy may be analyzed at different sintering temperatures to determine desired properties such as density, grain, distribution of materials, and/or phase transitions. The refractory metal alloy may exhibit several improved properties when compared to nickel-based alloys that are conventionally used to form compact heat exchangers. For example, the refractory metal alloy may exhibit a tensile strength of greater than about 450 MPa at about 1600° C. The refractory metal alloy may be tested for sufficient tensile and creep strength. For example, tensile and creep strength may be measured at temperatures ranging from about 25° C to 1600° C. Tensile and creep strength tests follow American Society for Testing and Materials (ASTM) standards E8, E21, and E139. The refractory metal alloy according to embodiments of the disclosure may exhibit a thermal conductivity ranging from about 115 W/(m-° C) to about 175 W/(m-° C) whereas conventional nickel-based alloys may exhibit thermal conductivity of 20-28 W/(m-° C) and much lower tensile strength under substantially identical or similar conditions.

The refractory metal alloy may also exhibit improved corrosion resistance, by about 200% or greater, when compared with conventional nickel-based alloys, such as Hastelloy N, which itself was designed to provide corrosion resistance. Corrosion resistance improves the service life of the heat exchanger 100 in extreme operating environments. Corrosion resistance may be tested by exposing the refractory metal alloy to static salts in sealed chambers and by exposing the refractory metal alloy to flowing salts in a controlled loop. For example, exposing the refractory metal alloy to static salts may include exposing the samples to salts at a temperature of about 700° C for about 500 hours. Exposing the refractory metal alloy to flowing salts may include exposing the refractory metal alloy to salts at a temperature between about 600° C and 700° C for about 1000 hours. The refractory metal alloy may be analyzed after exposure to either static or flowing conditions for changes in mass and examined to determine the depth of any wear on a surface of the refractory metal alloy.

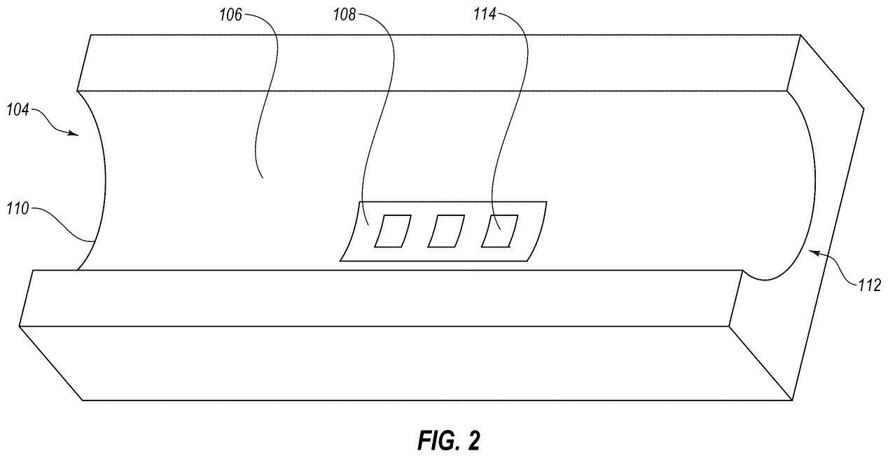

FIG. 2 shows a cross-sectional perspective view of a portion of the fluid passageway 104 of the heat exchanger 100. The fluid passageway 104 includes an inner wall 106 that defines a channel, an inlet 110, and an outlet 112. The fluid passageway 104 may include a sensor 108 disposed on the inner wall 106 of the fluid passageway 104. The sensor 108 may be a multimodal sensor configured to collect data about at least two independent characteristics, such as collecting strain and temperature data, within the fluid passageway 104. In some embodiments, the sensor 108 may be configured to collect data about more than two independent characteristics. For example, a portion of the sensor 108 is configured as a strain gauge and another portion of the sensor 108 is configured as a thermocouple. A junction 114 (e.g., a gold-ITO junction) of the sensor 108 may be configured to act as a thermocouple. At least a portion of the sensor 108 may be formed to include gold, and at least a portion of the sensor 108 may be formed to include indium tin oxide (ITO). The sensor 108 may include one or more junctions 114. In some embodiments, the sensor 108 may include silver, platinum, ruthenium, iridium, titanium diboride, tantalum nitride, metal alloys, and metal oxides. The portion of the sensor 108 including gold may be configured as a strain gauge. The portion of the sensor 108 including junctions 114 may be configured to act as a thermocouple.

The sensor 108 facilitates, for example, measurement of strain and temperature sensing of the fluid passageway 104 during use and operation of the heat exchanger 100. Both the strain and temperature sensing may be performed substantially simultaneously. The sensor 108 may also facilitate continuous monitoring of the heat exchanger 100 during operation. A high-frequency alternating current (AC) may be inputted to the sensor 108, which produces an AC resistive voltage. This voltage may be measured to determine the change in resistance of the sensor 108 and the corresponding strain on the fluid passageway 104. A direct current (DC) Seebeck voltage across the thermocouple is used to determine changes in temperature of the fluid passageway 104 and or a fluid moving through the fluid passageway 104 without interfering with the AC resistive voltage across the same thermocouple. The sensor 108 may exhibit a gauge factor of about 5 and a thermopower output of about 55.4 μV/° C.

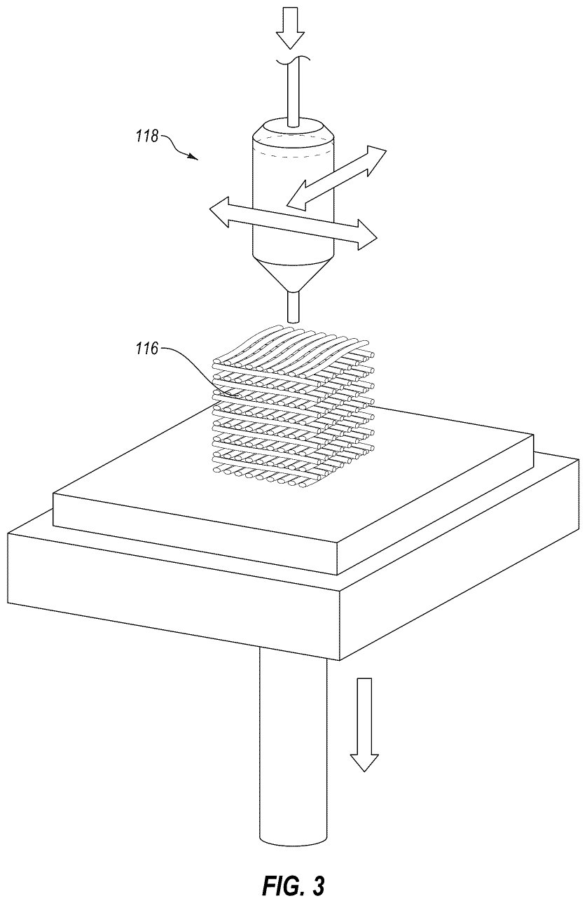

FIG. 3 to FIG. 8 show various acts of methods of producing the heat exchanger 100 of FIG. 1 according to embodiments of the disclosure. FIG. 3 shows a side elevational view of a shapeholder 116 and an extrusion printing system 118 used to produce the shapeholder 116. The shapeholder 116 is configured to represent a negative pattern (e.g., negative image) of the fluid passageways 104 within the heat exchanger 100. The shapeholder may also be referred to as a plurality of sacrificial channel molds. As described in detail below, the shapeholder 116 is used during formation of the heat exchanger 100 and later removed from the heat exchanger 100, leaving behind the fluid passageways 104 configured in the negative pattern of the shapeholder 116. The shapeholder 116 may be formed through a 3D printing process, such as extrusion printing, digital light projection (DLP), or other 3D printing methods that facilitate formation of shapeholder 116. The shapeholder 116 is not limited to the geometry shown in FIG. 3, but may take on any desired geometry including complex, three-dimensional geometries and tailorable surfaces to enhance heat transfer properties of the heat exchanger 100. In addition to different geometries, the heat exchanger 100 may be formed as different macro-and micro-structures than as illustrated. For example, the geometry of the shapeholder 116 may affect fluid mixing, turbulent flow, surface area-to-volume ratio, and other modifications within the fluid passageways 104 to improve overall heat transfer of the heat exchanger 100. Using a 3D printing process to form the shapeholder 116 facilitates the formation of near-net-shape shapeholders 116. In some embodiments, at least a portion of the shapeholder 116 may be sintered up to about 1200° C. to remove rheological modifiers from the shapeholder 116.

The material of the shapeholder 116 may be selected so as to facilitate the formation of the heat exchanger 100 while being removable to leave behind the fluid passageways 104. The material may thus have a melting point that is above a sintering temperature of the refractory metal alloy used for the body 102. This helps to prevent the shapeholder 116 from having a liquid phase during consolidation of the refractory metal alloy, which may result in the material of the shapeholder 116 infiltrating powder interstices or in the material contaminating the matrix and potentially causing channel collapse due to the loss of structural integrity.

The material of the shapeholder 116 may exhibit compatibility with additive manufacturing processes, including accommodating processes of large scale and/or complex geometries. The material of the shapeholder 116 may also have adequate structural strength for handling during assembly, powder loading, and the sintering process. The material may also readily react with a chosen solvent for removing the shapeholder after sintering/consolidation of the body 102. Furthermore, the material may be chosen to be chemically inert during sintering relative to the chosen refractory metal alloy of the body 102.

The material of the shapeholder 116 may include a ceramic material due to a relatively high melting point, thermal stability, and additive manufacturing compatibility of ceramic materials. Such ceramic materials for the material of the shapeholder 116 may include, but are not limited to, alumina, zirconia, calcium oxide (CaO), calcium carbonate (CaCO₃), boron nitride, a carbon filled composite material, a mixed formation of 40CaCO₃+20Ca₃(PO₄)₂+25Al₂O₃+10MgO+5CaSiO₃ (wt. %), or a combination thereof. In some examples, Al₂O₃ may be incorporated as a reinforcing phase. These ceramic materials may react with hydrochloric acid (HCl) to allow for removal of the shapeholder 116 from the body 102 after sintering/consolidation of the body 102. In some embodiments, the shapeholder 116 is a carbon filled composite material. The shapeholder 116 may include 5% calcium carbonate in alumina.

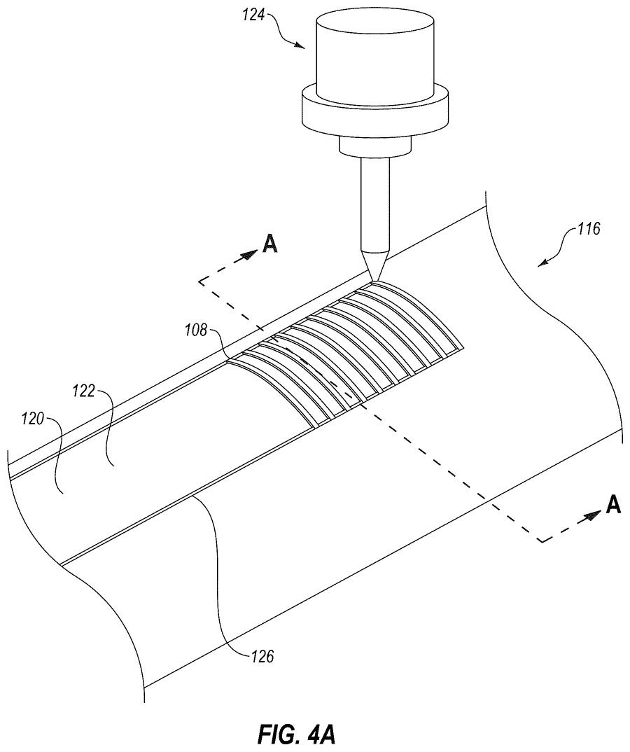

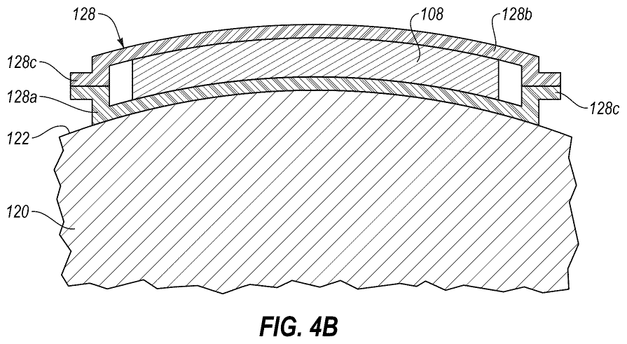

Referring now to FIG. 4A, the shapeholder 116 may include one or more elongated bodies 120 arranged in a complex three-dimensional shape that corresponds to the spaces of the fluid passageways 104 of the heat exchanger 100. An outer surface 122 (see FIG. 4A and FIG. 4B) of the elongated bodies 120 is substantially complementary to the inner wall 106 (FIG. 2) of the fluid passageway 104.

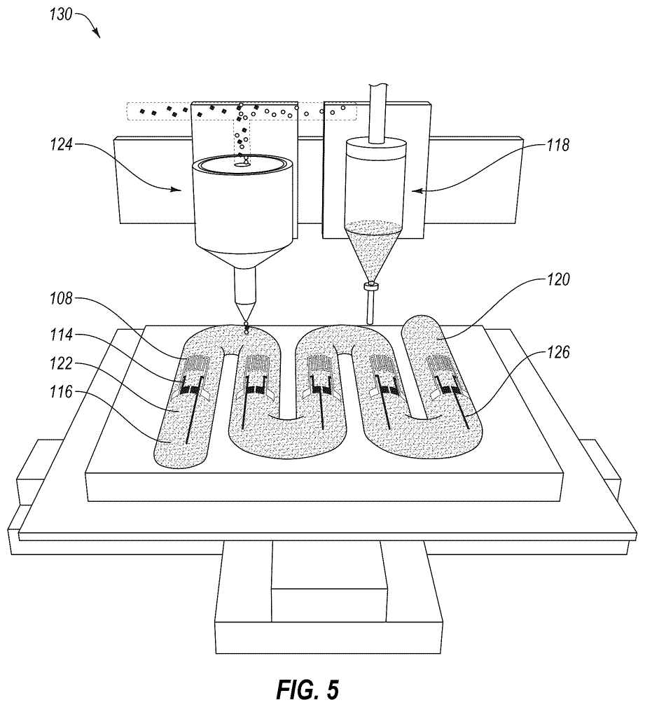

Referring to FIG. 4A, FIG. 4B and FIG. 5, the sensor 108 may be formed on the outer surface 122 of the elongated bodies 120 of the shapeholder 116. FIG. 4A shows the sensor 108 being printed on the outer surface 122 by an aerosol jet printing (AJP) system 124. The AJP system 124 is configured to deposit, for example, thermocouple and strain gauge portions of the sensor 108 onto the shapeholder 116 during the same manufacturing process. The AJP system 124 facilitates 3D printing of the sensor 108 directly onto components of any 3D geometry. The AJP system 124 also allows for nonintrusive implementation of the sensor 108 with thermal contacts and mechanical coupling within the fluid passageway 104, resulting in highly accurate temperature and strain measurements. The AJP system 124 facilitates microscale sensor printing with a spatial resolution of about 10 μm. Microscale printing resolution facilitates printing miniaturized sensor arrays with high spatial resolution and also facilitates high temporal resolution due to small sensor thermal masses and fast responses. High spatial and temporal resolution of the sensor 108 facilitates collecting of large volumes of data that can be used for constructing a machine learning (ML)-based digital tool for structural health monitoring (SHM) and predictive maintenance of the heat exchanger 100.

Referring to FIG. 4B, a dielectric layer may be formed (e.g., printed) to encapsulate the sensor 108 and provide electrical insulation between the sensor 108 and other portions of the heat exchanger 100 and fluids within the heat exchanger during use. In some embodiments, the dielectric layer may be formed as a ceramic capsule 128 that is 3D printed on the outer surface 122 of the elongated bodies 120 of the shapeholder 116. The ceramic capsule 128 receives and encloses the sensor 108 and at least one lead 126 on the outer surface 122 of the elongated body 120. The ceramic capsule 128 includes a contoured base 128a that conforms to the outer surface 122, and a cover 128b overlying the sensor 108. The cover 128b and the base 128a may interface at a flange 128c (e.g., a peripheral flange). The flange 128c extends around the interface of the base 128a and the cover 128b to encapsulate the sensor 108 and the lead 126 on the elongated bodies 120. The ceramic capsule 128 is configured to inhibit infiltration of surrounding material during subsequent consolidation of the heat exchanger 100. The flange 128c may provide a sealing interface between the base 128a and the cover 128b and may mechanically lock the ceramic capsule 128 relative to the refractory metal that later forms the body 102. In some embodiments, the base 128a and the cover 128b of the ceramic capsule 128 may be sealed together at the interface prior to subsequent consolidation of the heat exchanger 100. In some embodiments, the base 128a and the cover 128b of the ceramic capsule 128 may be sealed together at the interface during subsequent consolidation of the heat exchanger 100. The sensor 108 (including, where present, junctions 114) and the lead 126 are fully embedded between the base 128a and cover 128b so as to be mechanically retained and dielectrically isolated from the refractory metal that later forms the body 102 and inner wall 106 of the heat exchanger 100.

In some embodiments, the ceramic capsule 128 and the sensor 108 may be sintered prior to further processing acts to form the heat exchanger 100. Sintering the sensor 108 may consolidate the particles printed by the AJP system 124 into a dense, thermally stable, and mechanically robust structure and facilitate interfacial bonding between different layers of the sensor 108 and at the interface of the base 128a and cover 128b of the ceramic capsule 128 at the flange 128c. The sintering of the sensor 108 and the ceramic capsule 128 may include thermal sintering in a furnace with a controlled atmosphere and/or photonic sintering using laser or flash lamps. The sintering conditions of the sensor 108 and ceramic capsule 128 may be adjusted to achieve stable sensor performances at high temperatures and under repeated thermal cycling.

The ceramic capsule 128 may be formed of any suitable material having sufficient thermal stability, additive manufacturing compatibility, and chemical inertness during subsequent sintering of, and removal of the shapeholder 116 from, the body 102. Such materials may include, but are not limited to alumina, aluminum nitride, boron nitride, or yttria-stabilized zirconia (YSZ).

Referring to FIG. 5, the extrusion printing system 118 and the AJP system 124 may be used together, as a larger, single additive manufacturing system 130, to reduce production time of the shapeholder 116, the sensors 108, and the ceramic capsule 128. The extrusion printing system 118 may be used to form the shapeholder 116 and the AJP system 124 may be used to form the sensors 108, leads 126, and the ceramic capsule 128 on the shapeholder 116. In some embodiments, different types of systems may be used in combination. For example, the AJP system 124 may be combined with a DLP system or another 3D printing system.

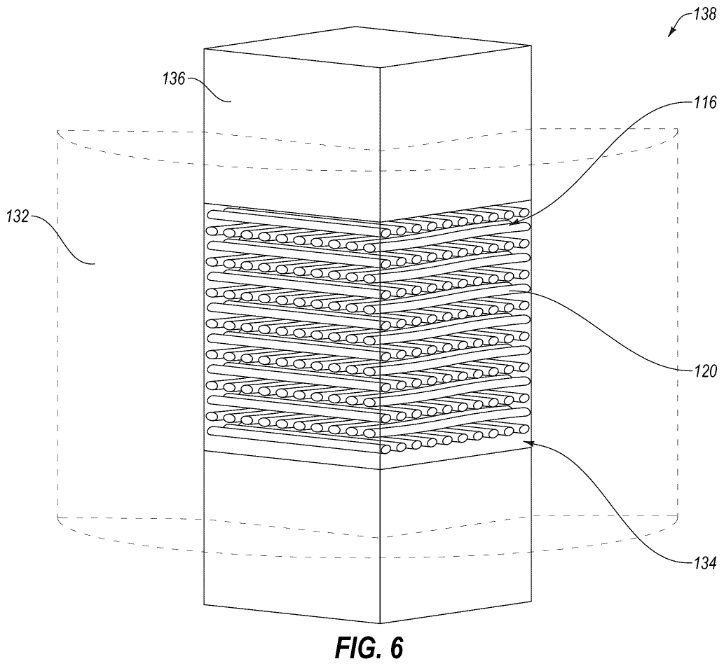

FIG. 6 shows the shapeholder 116 loaded into a die 132 of a sintering assembly, with a refractory metal powder 134 infiltrating around the elongated bodies 120 of the shapeholder 116. The refractory metal powder 134 is a powder formed of the refractory metal alloy that will form the body 102 of the heat exchanger 100. Two punches 136 may be located at opposing longitudinal ends of the die 132. The punches 136 may be at least partially received within the die 132. The die 132 and the punches 136 may be part of a sintering system 138. The sintering system 138 may be, for example, an electric field-assisted sintering (EFAS) that enables cost-effective and industry-scale production of advanced metallic, ceramic, and composite materials.

EFAS, also known as spark plasma sintering (SPS) or field-assisted sintering technology (FAST), is an advanced manufacturing technology that utilizes electric current and applied pressure to consolidate materials. The electric current-generated Joule heating associated with EFAS differentiates EFAS from conventional hot pressing (HP) and hot isostatic pressing (HIP). EFAS has several distinctive characteristics. EFAS has very fast heating rates (hundreds of degrees per minute), low processing time (seconds to a few minutes), and high productivity. EFAS consumes only 15-30% of energy compared with other sintering techniques, such as HP and HIP, that require long processing times (hours and days). EFAS facilitates rapid densification of hard-to-sinter materials, including refractory metal alloys, composites, and ceramics. A few examples include the densification of TZM alloys in 2.5 minutes and MoNbTaTiV alloy in 15 minutes. Rapid production by EFAS may achieve unique microstructures and mechanical properties of the heat exchanger 100, which are often difficult or impossible to achieve otherwise. Using EFAS to make the compact heat exchanger 100 according to embodiments of the disclosure may reduce energy consumption by greater than 70% and reduce production cost by greater than 30% when compared to conventional production methods of compact heat exchangers. Reduced energy consumption by using EFAS also facilitates reduced carbon emissions. In some embodiments, EFAS may be conducted at temperatures within a range of from about 1200° C to about 1800° C, a pressure of from about 30 MPa to about 80 MPa, for a time of from about 2 minutes to about 30 minutes.

FIG. 7 shows the heat exchanger 100, with the shapeholder 116 disposed therein after the EFAS process has turned the refractory metal powder 134 into a solid body forming the body 102 of the heat exchanger 100. As shown in FIG. 7, after the EFAS process, the body 102 includes the shapeholder 116 embedded therein.

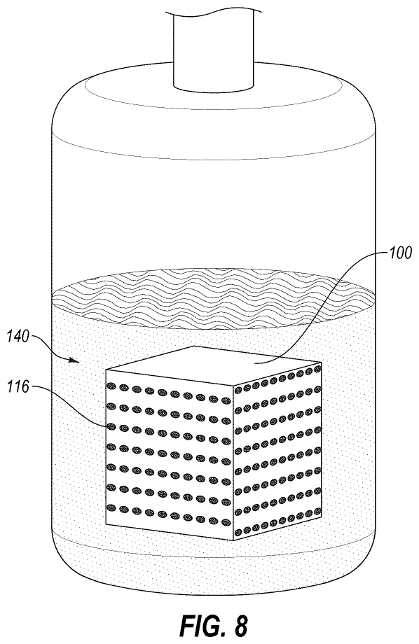

Referring to FIG. 8, the heat exchanger 100 with the shapeholder 116 still embedded therein may be exposed to a chemical solution 140, which dissolves the shapeholder 116. The chemical solution 140 is formulated to substantially remove the shapeholder 116, defining the fluid passageways 104. In some embodiments, the chemical solution 140 may be hot water, hydrochloric acid, or another chemical compound. The choice of chemical for the chemical solution 140 depends on the material used for the shapeholder 116. For example, alumina and zirconia may be effectively dissolved using chemical compounds, such as HF and NaOH, while the refractory metal alloys defining inner walls 106 of the fluid passageway 104 and the ceramic capsule 128 formed at the inner walls 106 of the fluid passageways 104 are not reactive with these chemical compounds. After the shapeholder 116 is removed, the heat exchanger 100 of FIG. 1 is produced, having one or more sensors 108 within (e.g., embedded within) the fluid passageway 104.

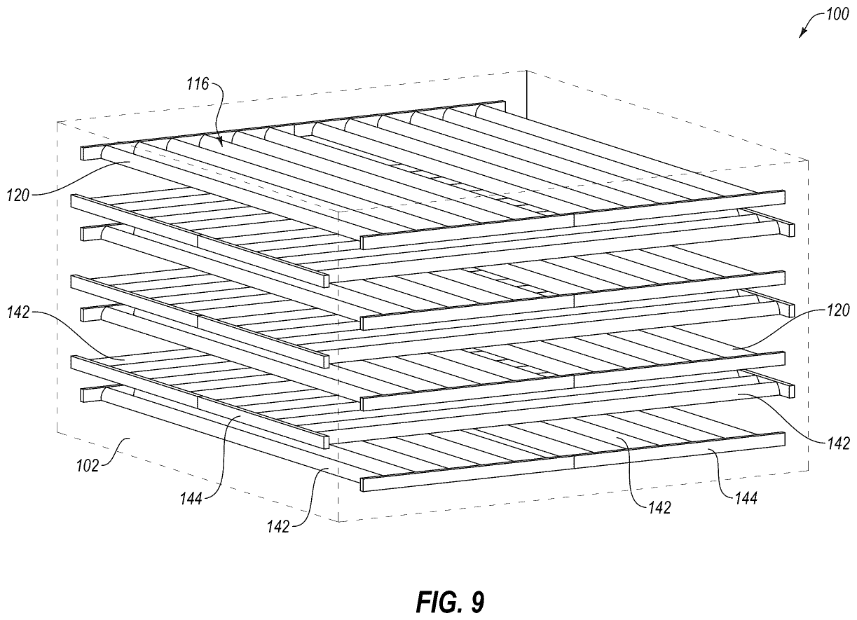

FIG. 9 is a perspective view of a heat exchanger 100 showing the shapeholder 116 formed as a stack of sacrificial channel molds 142 within a boundary corresponding to the body 102. Each sacrificial channel mold 142 includes a plurality of elongated bodies 120 that are joined (e.g., tied) together by bridge members 144 at one or both ends to maintain registration during handling and consolidation. By maintaining registration, the bridge members 144 maintain an orientation and/or a positional relationship of one elongated body 120 relative to other elongated bodies 120 of the sacrificial channel mold 142. In FIG. 9, successive sacrificial channel molds 142 are alternated with intervening beds of refractory metal powder (e.g., powder 134, see FIG. 6), so that the powder layers set the spacing between adjacent levels of sacrificial channel molds 142 prior to densification. In some embodiments, the bridge members 144 of successive sacrificial channel molds 142 are made continuously from level to level to form a ladder-type scaffold so that the stack of sacrificial channel molds 142 self-maintains the inter-level spacing. In this case, the powder to form the body 102 of the heat exchanger 100 can be added in a single operation before densification. After densification (e.g., via EFAS) and removal from the die, the bridge members 144 are removed together with the sacrificial channel molds 142 to open the fluid passageways 104 of the heat exchanger 100. The body 102 may then be trimmed away to yield the final block geometry, as desired.

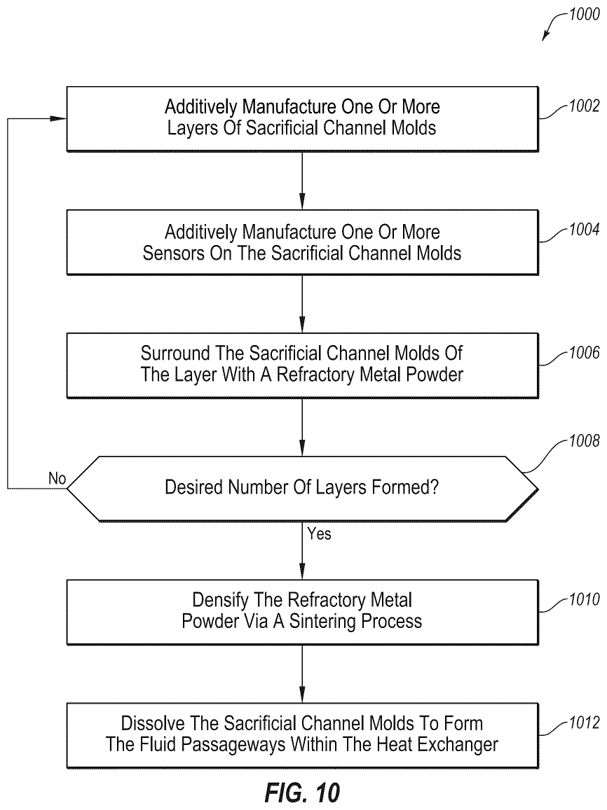

FIG. 10 is a flowchart 1000 showing a method of forming the heat exchanger 100 with embedded sensors 108. In act 1002, one or more layers of the shapeholder (e.g., one or more sacrificial channel molds 142 of the shapeholder 116) are additively manufactured to define the negative of the fluid passageway(s) 104. The sacrificial channel molds 142 are formed with accessible surfaces (e.g., outer surface 122 of elongated bodies 120) suitable for subsequent sensor printing thereon.

In act 1004, one or more sensors 108 are additively manufactured on the shapeholder 116 (e.g., on the elongated bodies 120 of the sacrificial channel molds 142), and, as part of the same printing sequence, a ceramic capsule 128 and lead(s) 126 are formed to encapsulate and provide electrical routing to the sensor 108. In some embodiments, a contoured base 128a is first deposited on the outer surface 122 (e.g., via ceramic extrusion/direct ink writing). The sensor elements (including any junctions 114) and the lead(s) 126 are then printed (e.g., by aerosol-jet) onto the base 128a; and a cover 128b is deposited to overlie the sensor and leads, optionally with a peripheral flange 128c to improve retention and inhibit metal infiltration during consolidation. The ceramic capsule 128 thus provides dielectric isolation of the sensor 108 and lead 126 subassembly from the refractory metal alloy that will later form the body 102 and inner wall 106.

In act 1006, the sacrificial channel molds 142 of the current layer of the shapeholder 116 are surrounded with refractory metal powder 134, packing the interstices to define the regions that will become the consolidated metal structure during densification. Additional powder may be added to fully cover the current layer of the shapeholder 116 and to space the current layer from the next layer of the shapeholder 116 to be formed. In act 1008, if the desired number of layers has not been formed, acts 1002-1006 are repeated to build additional shapeholder layers (and associated printed sensor/capsule features). Otherwise, processing proceeds to act 1010. In an alternative embodiment, the layers of the sacrificial channel molds 142 with the ceramic capsule 128 and sensors 108 printed thereon are spaced apart via the additive manufacturing of the bridge members 144. For example, the bridge members 144 of the sacrificial molds of two or more adjacent levels are additively manufactured to connect together to maintain a vertical spacing between levels of the sacrificial channel molds 142 of the shapeholder 116. After the two or more adjacent levels are additively manufactured together, the refractory metal powder 134 is added which fills the interstices between the elongated bodies 120 of the sacrificial channel molds 142 and between the levels of the sacrificial channel mold 142.

In act 1010, the refractory metal powder 134 is densified via a sintering process (e.g., electric-field-assisted sintering) to consolidate the refractory metal powder 134 into the body 102. The refractory metal powder 134 is consolidated around the ceramic capsules 128 on the outer surfaces 122 of the elongated bodies 120 of the shapeholder 116, maintaining the spatial relationship of the ceramic capsules 128 along the inner walls 106 of the fluid passageway(s) 104. Representative EFAS ranges (temperature, pressure, and time) suitable for consolidating refractory powders may be those described above.

In act 1012, the sacrificial channel molds 142, including the bridge members 144 if present, of the shapeholder 116 are dissolved. In some embodiments, the shapeholder 116 is dissolved in the chemical solution 140 chosen to remove the shapeholder material without deleteriously affecting the consolidated refractory metal or the ceramic capsule 128, forming the fluid passageway(s) 104 with the encapsulated sensor 108 and co-printed lead(s) 126 disposed at the inner wall 106.

Following act 1012, the fluid passageways 104 may be monitored to determine complete mold removal. Act 1012 may be repeated as necessary to remove substantially all of the sacrificial channel mold material. If desired, channel-wall surface conditioning may be applied to remove loose inclusions and smooth roughness. A thin porous “SCM-affected zone” may remain at the refractory-metal surface (e.g., the inner walls 106) after dissolution due to sacrificial channel mold infiltration of powder boundaries. This zone (e.g., ˜tens of microns) may be mitigated by conducting a chemical polish/etch, mechanical polish/peen, localized re-densification cycle, or application of a sealing washcoat.

Leak-tightness and integrity of the body 102 and inner wall 106 may be verified, and the ceramic capsule 128 may be confirmed to remain intact at the inner wall 106. Electrical checkout of sensor 108 and lead(s) 126 may be performed. External pads/connectors may be attached to the leads 126 where the design routes the leads to an accessible region (e.g., near an inlet 110/outlet 112 of the fluid passageway 104).

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A heat exchanger, comprising:
a body formed of a refractory metal alloy, the body defining one or more fluid passageways therein; and
a sensor embedded in an inner surface of the one or more fluid passageways.

2. The heat exchanger of claim 1, wherein the heat exchanger is configured to operate at an operating temperature of greater than about 750° C.

3. The heat exchanger of claim 1, wherein the sensor is configured to measure strain and temperature change of the body.

4. The heat exchanger of claim 1, further comprising a ceramic capsule disposed at the inner surface of the one or more fluid passageways, the sensor being encapsulated within the ceramic capsule.

5. The heat exchanger of claim 4, further comprising a lead extending from the sensor along the inner surface of the one or more fluid passageways.

6. The heat exchanger of claim 5, wherein the lead is encapsulated within the ceramic capsule.

7. The heat exchanger of claim 4, wherein the ceramic capsule comprises a base and a cover sealed to the base at an interface, and a flange disposed at the interface.

8. A method of forming a heat exchanger, the method comprising:
additively manufacturing a shapeholder comprising elongated bodies that correspond to fluid passageways to be defined within a body;
additively manufacturing one or more sensors on the elongated bodies of the shapeholder;
forming a material of the body around the elongated bodies of the shapeholder;
sintering the material of the body around the elongated bodies of the shapeholder and the one or more sensors; and
removing the shapeholder from the body, leaving the one or more sensors embedded at an inner surface of the fluid passageways.

9. The method of claim 8, wherein sintering the material of the body comprises sintering the material at a temperature within a range of from about 1200° C to about 1800° C.

10. The method of claim 8, wherein additively manufacturing the shapeholder comprises additively manufacturing levels of sacrificial channel molds.

11. The method of claim 10, further comprising surrounding the sacrificial channel molds with a powder of the material of the body to maintain spacing between the levels prior to sintering.

12. The method of claim 10, wherein additively manufacturing levels of sacrificial channel molds comprises additively manufacturing the elongated bodies and bridge members connecting ends of the elongated bodies to maintain a registration of the elongated bodies.

13. The method of claim 12, wherein additively manufacturing levels of sacrificial channel molds comprises additively manufacturing the bridge members to connect together to maintain vertical spacing between the levels of the sacrificial channel molds.

14. The method of claim 8, wherein additively manufacturing one or more sensors on the elongated bodies comprises additively manufacturing a ceramic capsule on an outer surface of an elongated body and encapsulating the one or more sensors within the ceramic capsule.

15. The method of claim 14, wherein additively manufacturing the ceramic capsule comprises additively manufacturing a base of the ceramic capsule onto the outer surface, additively manufacturing the one or more sensors onto the base, and additively manufacturing a cover of the ceramic capsule over the base and the one or more sensors.

16. A shapeholder for use in forming a heat exchanger with one or more sensors embedded within fluid passageways of the heat exchanger, the shapeholder comprising:
elongated bodies configured in a negative pattern corresponding to the fluid passageways of the heat exchanger;
a ceramic capsule disposed on an outer surface of one or more of the elongated bodies; and
a sensor disposed within the ceramic capsule,
wherein the elongated bodies comprise a first material that is reactive to a chemical solution and wherein the ceramic capsule comprises a second material that is resistant to the chemical solution.

17. The shapeholder of claim 16, further comprising a lead disposed within the ceramic capsule and extending along the outer surface of the one or more of the elongated bodies.

18. The shapeholder of claim 16, wherein the ceramic capsule comprises a base and a cover over the base, the base and the cover being sealed together at an interface.

19. The shapeholder of claim 18, wherein the ceramic capsule forms a flange at the interface between the base and the cover.

20. The shapeholder of claim 16, further comprising bridge members connecting ends of the elongated bodies.
